(19) United States
(12) Patent Application Publication
(10) Pub. No.: US 2004/0061961 A1
(43) Pub. Date: Apr. 1, 2004

(54) Pivoting optical micromirror, array for such micromirrors and method for making same

(76) Inventor: Serge Valette, Grenoble (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/468,060

(22) PCT Filed: Feb. 13, 2002
(86) PCT No.: PCT/FR02/00545

(30) Foreign Application Priority Data
Feb. 15, 2001 (FR) 01/02065

(51) Int. Cl. G02B 7/182

(52) U.S. Cl. 359/872; 216/24

(57) ABSTRACT

This invention relates to a micro-mirror comprising a fixed part (31), a movable part (41, 48) comprising means of reflection (48) and means of articulation linking the movable part to the fixed part, this micro-mirror is characterised in that the means of articulation are made of a pivot hinge (47) located under the movable part between the latter and the fixed part and capable of allowing displacement of the movable part according to axes of rotation contained in the movable part and going through the axis of the pivot hinge, and in which the fixed comprises at least a cavity (36) facing at least a zone of an end of the movable part.

The invention also relates to a matrix of pivoting micro-mirrors and a manufacturing process of such micro-mirrors. These micro-mirrors can notably be used in optical routing systems or in image projection systems.

### FIELD OF THE INVENTION

This invention relates to a pivoting optical micro-mirror as well as a matrix of such micro-mirrors and its manufacturing process. This micro-mirror is capable of being electrically controlled.

Micro-mirrors are generally used in systems putting into play deflections of light beams and in particular in optical routing systems or in image projection systems.

### BACKGROUND OF THE INVENTION

Electrically-controlled micro-mirrors (most of the time using electrostatic, electromagnetic, piezoelectric or thermoelastic forces) capable of generating digital or analogue angular positions are documented. They generally use hinged configurations allowing, depending on the complexity of the technological stages put into play, the oscillation around an axis (single hinge) or two axes of rotation (double hinge) most of the time orientated in an orthogonal manner.

FIG. 1a shows a view of such an electrostatically-controlled micro-mirror allowing rotation according to two perpendicular axes, used in optic routing systems. Fitted onto support 1 are: the fixed plate 2 of the micro-mirror and the movable parts 3 and 4 respectively articulated around the hinges 5 and 6 which allow the desired rotations around the two orthogonal axes. Each of the axes of rotation goes through a separate hinge. The movable part 4 is covered in a layer of highly reflective material.

FIG. 1b gives a skeletal sectional view of the different elements constituting this type of micro-mirror (section through the axis of the hinge 5). In this figure, the different control electrodes 7, 8, 9 and 10 of the micro-mirror have also been represented. The electrodes 7 and 8 facing each other, allow the movable part 3 to turn around the hinge 5, whereas the electrodes 9 and 10 facing each other, allow the movable part to turn around the hinge 6.

The movable part of the hinged micro-mirrors has restricted degrees of freedom. Indeed, each hinge can only provide one axis of rotation for the movable part, this axis lying in the plane of the movable part and going through the hinge. Hence, to increase the degrees of freedom of the movable part, it is necessary to divide the movable part into independent patterns, located in the same plane and respectively can be articulated by a hinge, which complicates the structure without even offering it a large number of degrees of freedom. To date, only double-hinged micro-mirrors have been manufactured.

The references cited at the end of the description give examples of hinged micro-mirrors.

### SUMMARY OF THE INVENTION

The subject of the invention is an optical micro-mirror compensating the inconveniences of the prior art and possessing a movable part that has a large number of axes of rotation whilst proposing a manufacturing process of such a micro-mirror that is easy to implement.

More precisely, the micro-mirror of the invention comprises a fixed part, a movable part comprising means of reflection, the micro-mirror further comprising means of articulation linking the movable part to the fixed part; this micro-mirror is characterised in that the means of articulation are made of a pivot hinge located under the movable part between the latter and the fixed part and capable of allowing displacement of the movable part according to the axes of rotation contained in the movable part and going through the axis of the pivot hinge.

According to the invention, a large number of axes of rotation are available for the movable part, as this part can pivot around the pivot hinge and trace, in the case of a circular movable part, a cylinder. The axes of rotation of the movable part correspond to all the radii tracing a semicircle whose centre is the pivot hinge.

In general, the pivot hinge is centred under the movable part but it can be easily envisaged in special applications to have an off-centre pivot hinge under the movable part and/or even a movable part of irregular thickness hence privileging certain axes of rotation and/or certain directions of rotation.

The micro-mirror of the invention advantageously further comprises means of electrically controlling the displacement of the movable part according to all or some of the said axes of rotation.

According to an embodiment, the means of electric control comprise a set of electrodes, known as lower, placed on the fixed part facing the movable part and a set of electrodes, known as upper, placed on the movable part facing the lower electrodes.

Preferably, the set of lower electrodes comprises at least 2.n electrodes placed in sectors around the axis of the pivot hinge, n being the chosen number of axes of rotation that can be attributed to the movable part and the set of upper electrodes comprises a single electrode placed so as to face at least part of each of the 2.n lower electrodes.

According to another embodiment, the set of upper electrodes comprises at least 2.n electrodes placed in sectors around the pivot hinge, n being the chosen number of axes of rotation that can be attributed to the movable part and the set of lower electrodes comprises a single electrode placed so as to face at least part of each of the 2.n upper electrodes.

A combination of these two embodiments can also be envisaged.

The means of electric control further comprise lines of connection and connectors on the ends of the lines to link the lower and upper electrodes to an electronic control unit. According to a first embodiment, the lines of connection and the connectors are advantageously fitted to the fixed part facing the movable part, the set of upper electrodes being linked to one or several of these lines via the pivot hinge and one or several electrodes placed under the pivot hinge, on the fixed part. According to another embodiment, the lines of connection consist of metallic holes through the fixed part, the set of upper electrodes being linked to one or several of these metallic holes via the pivot hinge and one or several electrodes placed under the pivot hinge, on the fixed part; the connectors being located at the ends of these holes on the side of the fixed part that is opposite to the one bearing the lower electrodes.

The invention can also use means of electric control employing forces other than electrostatic forces, for example electromagnetic, piezoelectric or even thermoelastic forces. By way of illustration, the control of the movable parts through magnetic forces (Laplace forces) requires windings and magnets adapted to generate the necessary magnetic fields.

According to an advantageous embodiment of the invention allowing a large angular excursion of the movable part, the fixed part comprises at least one cavity facing at least one zone of one of the ends of the movable part, of geometric shape and dimensions so as to render the dimensional parameters of the movable part independent from the total angular excursion Δθ according to the different axes of rotation.

Advantageously, this cavity is peripheral and faces a peripheral zone of the end of the movable part.

According to the invention, the means of reflection comprise a layer of reflective material applied on the side of the movable part that is opposite to the one facing the fixed part.

According to a preferred embodiment of the invention, the fixed part is in silicon, the first layer is in thermal silicon dioxide, the second layer is in single-crystal silicon and the pivot hinge is in single-crystal silicon.

The advantageous composition of the pivot hinge in single-crystal silicon allows the pivot hinge to have durable mechanical properties.

According to a particular embodiment of the micro-mirror of the invention, notably allowing the number of degrees of freedom to be increased, the latter comprises on the fixed part at least two superimposed movable parts: the first movable part is linked to the fixed part via a first pivot hinge comprising a first axis and the second movable part comprising means of reflection is linked to the first movable part via a second pivot hinge comprising a second axis; this micro-mirror further comprises means of control capable of displacing the first movable part around n₁ axes of rotation contained in this first part and going through the first axis and of displacing the second movable part around n₂ axes of rotation contained in this second part going through the second axis.

The first axis and the second axis are generally parallel. They can be identical or different. The means of control are of the same type as those used for a single movable part but in double. Hence, controlling the first movable part requires on one hand at least 2.n₁ electrodes and on the other hand at least one electrode respectively placed on the sides facing the fixed part and the movable part (or visa versa); and controlling the second movable part requires on one hand at least 2.n₂ electrodes and on the other hand at least one electrode respectively placed on the sides facing the fixed part and the second movable part (or visa versa). This principle can of course be extended to more than two movable parts, with at least the last movable part comprising means of reflection.

Of course the pivot hinge can be made just as well from a homogeneous pattern as from a multi-element pattern. A multi-element pattern can correspond to superimposing materials as much parallel to the axis of the pivot hinge as perpendicular to this axis and enabling the use of different materials capable of giving, through their combination, mechanical properties (mechanical strength/elasticity . . . ) and/or electric properties (conduction/insulation . . . ) that are impossible to obtain with a single material.

For example, a pivot hinge can be made with parallel conductive elements separated by insulation; these elements enable several electrodes of the movable part to be linked in an independent manner to independent lines of connection, generally, via electrodes, likewise independent, placed on the fixed part under these conductive elements.

The invention also relates to a matrix of pivoting micro-mirrors that can be controlled independently from each other as well as a manufacturing process of such a micro-mirror. This process, in particular allows for collective manufacturing of micro-mirrors and for example the making of a matrix of micro-mirrors.

According to the invention, the word matrix includes the array which is a particular type of matrix in which the elements are placed according to a single axis.

The manufacturing process of the micro-mirror of the invention comprises the following stages:

a) the making of a stack consisting of a mechanical support designed to constitute the fixed part, of a sacrificial layer of material called the first layer and a set designed to constitute the movable part and comprising at least one layer of material called the second layer;

b) the making of the pivot hinge;

c) the making of the movable part by etching at least the second layer of material so as to obtain at least one pattern;

d) the eliminating of the sacrificial layer so as to free the said movable part which is then linked to the rest of the structure corresponding to the fixed part, via the pivot hinge.

The stages of the process of the invention can be carried out in the previously stated order or in another order, moreover, in certain embodiments some of the stages can be integrated into other stages. According to the invention, the support or the layers are not necessarily made of a single material, thus, the support may have several layers and the layers may have several underlayers.

Preferably, the means of reflection are applied to the second layer through the depositing of single or multiple layers of reflective materials such as metals, for example gold, silver, aluminium or dielectric mediums, for example SiO₂/TiO₂ or SiO₂/HfO₂; these materials are deposited through, for example, cathode spluttering or vacuum evaporation on the second layer generally after stage b).

If the second layer is sufficiently reflective for the envisaged application, the means of reflection are then performed by the second layer itself.

Advantageously, the first layer is a layer of thermal oxidisation material, thus allowing it to have a very accurately-controlled thickness and to play the role of a sacrificial layer. The value of the angular excursion of the movable part is therefore very accurate and reproducible.

The thermal oxidation layer can be partially eliminated; it must be etched at least to allow the movable part to be freed.

Advantageously, the process further comprises an epitaxy stage for the second layer, the means of reflection then being applied on the second layer after epitaxy.

The epitaxy of the second layer allows to increase the thickness of this layer with the best possible mechanical continuity and to obtain a layer with little disfigurement and of very high mechanical quality (notably mechanical resistance) which maintains excellent flatness even after the freeing stage d).

According to a preferred embodiment of the invention, the second layer is a layer of single-crystal material. The use of single-crystal materials for the movable part allows good flatness of the surface onto which the reflective layer is applied.

According to a first embodiment of the invention, the stacking of stage a) can be obtained through the application of the sacrificial layer of material on the support, then the depositing of the second layer.

Therefore stage a) can either consist in stacking or taking directly a semiconductor wafer on insulator such as SOI (Silicon On Insulator) available on the market. In the latter case, by way of illustration, it is favourable to use the SOI substrates putting into play a layer of thermal silica (for example the wafers sold under the brand name Unibond by the company SOITEC).

According to a second embodiment of the invention, stage a) consists in, on the mechanical support, applying the second layer, the support and/or the second layer comprising on their sides to be applied a sacrificial layer which will form the first layer once after application.

Advantageously the sealing of the applied elements (support or oxide layer on one hand and second layer or oxide layer on the other hand) is performed through the molecular adhesion technique. A sealing element, for example glue, could have likewise been used for this sealing.

The second layer can be associated with an intermediate support via a connection zone capable of allowing the retraction of the intermediate support after application or in some special cases prior to application.

According to a first implementation of this application, this connection zone is an embrittlement obtained via ion implantation (see notably U.S. Pat. No. 5,374,564 and U.S. Pat. No. 6,020,252) and/or through the creation of porosity in the second layer, the retraction of the intermediate support is carried out according to this embrittlement zone via an appropriate treatment such as the application of mechanical forces, and/or the use of a thermal treatment.

According to a second implementation of this application, this connection zone is a sacrificial layer which is chemically etched to allow the retraction of the intermediate support.

The application technique used in this second method allows the implementation of several wafers and thus provides greater freedom in the making of structures, which can have several superimposed movable parts.

According to an advantageous embodiment, to make the pivot hinge, prior to stage d), a localised etching is carried out on the layer(s) located above the support so as to form a via and an epitaxy is carried out through the via, the epitaxy material in the via constituting all or part of the pivot hinge of the means of articulation.

The pivot hinge can be made in several parts, notably in the case of the second embodiment using the application of the second layer. Thus the pivot hinge is made via:

localised etchings prior to application so as to form a first via in the layer(s) located above the support, and so as to form a second via in the layer(s) located on the second layer, facing the support;

an epitaxy through the first via creating a first part of the pivot hinge and an epitaxy in the second via creating a second part of the pivot hinge, these two parts being placed face to face during the application and forming after the application the pivot hinge.

In the case of a pivot hinge with a multi-element pattern, comprising for example conductive elements parallel to the axis of the pivot hinge, these elements are for example made through a deposit (such as an epitaxy) in a via comprising insulation meshes (each mesh corresponding to an opening lined with insulation) so that these elements are insulated once finished.

Advantageously, the process of the invention puts into play a thinning of the second layer to reduce the inertia of the movable part and allow the operating of the micro-mirror at high frequencies.

This thinning of the second layer can be carried out either through the creation of an embrittlement zone at a depth in the second layer so that the remaining thickness, once the surplus has been removed (which could be that of an intermediate support), corresponds to the desired thickness of the second layer, or through a stage of chemical or reactive ion etching, or mechano-chemical polishing until the desired thickness, or even through a combination of all these techniques. If the thinning stage results in thicknesses too thin for the second layer, this thickness can be re-increased through an epitaxy stage.

According to an advantageous embodiment of the invention one or several cavities are made in the fixed part facing the movable part, advantageously via etching. Generally, a peripheral cavity is etched, facing a peripheral zone of the end of the movable part.

The cavities greatly increase the possibilities of displacement of the movable part. If they are directly performed in the fixed part, any spacing interlayer can be avoided, the interlayer can only provide restricted displacement considering its limited thickness. The cavities can preferably be made during stage a) of the aforementioned process.

It is however possible to make these cavities at any given time. If the cavities are made after stage a) of the process, it can be advantageous to etch them from a rear part of the fixed part, that meaning from a party which does not support the movable part.

According to an embodiment, the micro-mirror being controlled electrically, and the fixed part and the movable part being, at least in the facing parts, in semiconductive materials, the process of the invention comprises a stage to make the set of lower electrodes and the set of upper electrodes via an ion implantation of dopants followed or not by an appropriate thermal diffusion of the implanted dopants.

Advantageously, irrespective of the type of electrodes made, they can extend into regions of the fixed part located outside the cavities. This allows to adjust freely the depth of the cavities, and therefore the amplitude of displacement of the movable part, without increasing the distance between the electrodes facing each other (the control voltages of the micro-mirror being related to the distance between the electrodes facing each other).

The lines of connection of the electrodes to an electric control can be made in different ways and notably through an ion implantation of dopants followed or not by an appropriate thermal diffusion of the dopants. These lines are advantageously made on the surface of the fixed part facing the movable part, the set of upper electrodes being linked to one or several lines via the pivot hinge and one or several electrodes placed under the pivot hinge on the fixed part. Connectors can also be envisaged at the ends of these lines so as to connect them to the electric control.

According to another embodiment the lines of connection of the different electrodes consist of metallic holes through the fixed part, the set of electrodes of the movable part being linked to one or several of these metallic holes via the pivot hinge and one or several electrodes placed under the pivot hinge, on the fixed part; connectors can also be envisaged at the ends of these lines so as to connect them to the electric control.

The process of the invention applies particularly well to a collective manufacturing of micro-mirrors.

### BRIEF DESCRIPTION OF THE DRAWINGS

The characteristics and advantages of the invention clearly come out from the description given below. This description is based on real examples, given for explanation purposes and non-restrictive. It also refers to the annexed drawings, in which:

FIGS. 1a and 1b that have already been described, respectively illustrate by means of perspective and sectional diagrams a double hinge micro-mirror in the prior art;

FIGS. 2a to 2c represent, by means of sectional diagrams, different positions of a movable part linked to the fixed part via a pivot hinge according to the principle of the micro-mirror of the invention;

FIGS. 3a to 3i represent, by means of sectional diagrams, the different stages of a first manufacturing process of a pivoting micro-mirror of the invention;

FIGS. 4a to 4g represent, by means of sectional diagrams, the different stages of a second manufacturing process of the fixed part of a micro-mirror of the invention;

FIGS. 5a to 5g represent, by means of sectional diagrams, the different stages of a second manufacturing process of the movable part of a micro-mirror of the invention;

FIGS. 6a to 6e represent, by means of sectional diagrams, the different stages involved to make, after the application of the structures obtained in FIGS. 4g and 5g, a micro-mirror according to this second process;

FIGS. 7a to 7g represent, by means of sectional diagrams, the different stages of a third manufacturing process of the fixed part of a micro-mirror of the invention;

FIGS. 8a to 8c represent top views of different micro-mirrors of the invention showing in particular different electrode geometries allowing rotation around one (FIG. 8a), two (FIG. 8b) or four (FIG. 8c) axes of rotation; and

FIG. 9 represents, by means of a sectional diagram, a micro-mirror comprising two superimposed movable parts.

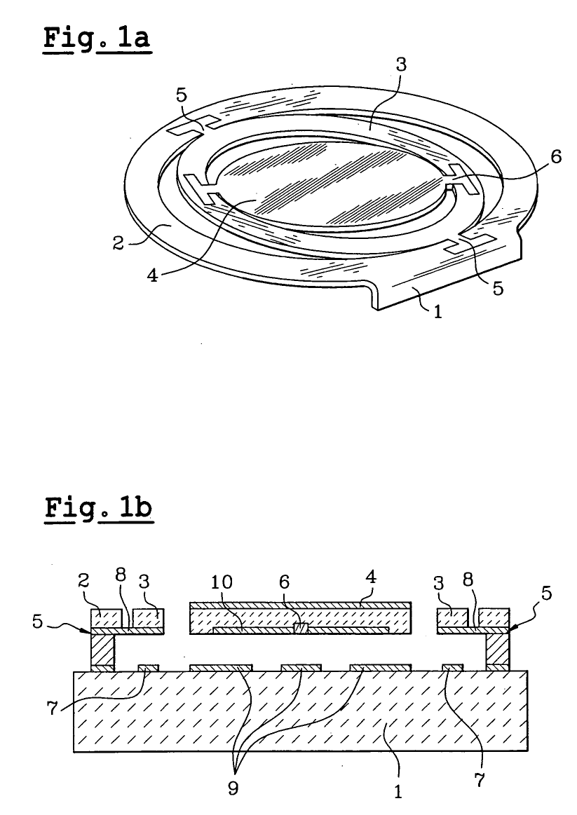

### DETAILED DISCLOSURE OF EMBODIMENTS

To simplify the overall description below, a centred pivot hinge and a movable part of even thickness will be used by way of example.

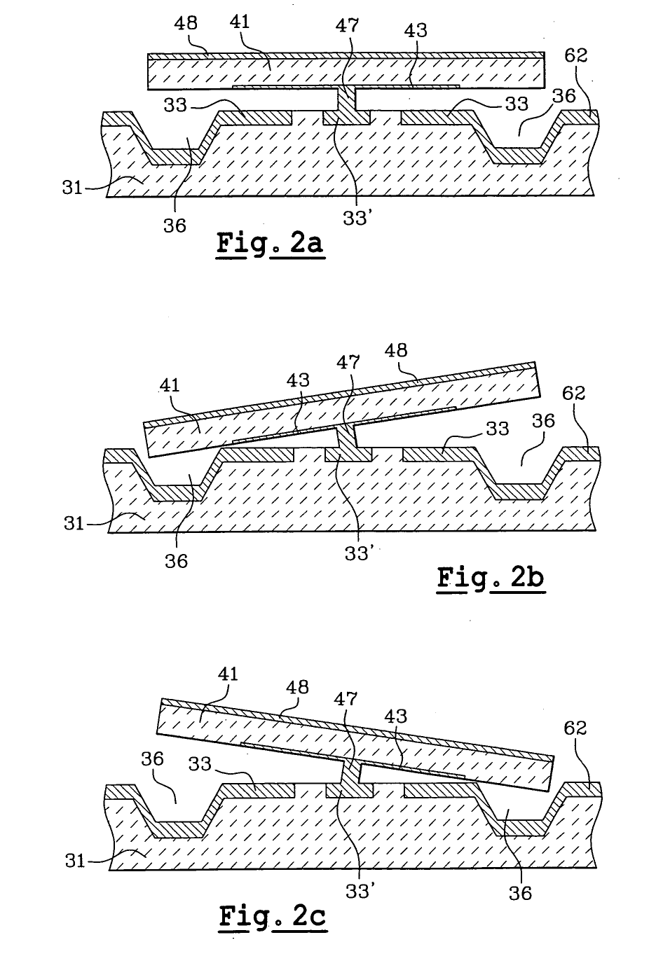

FIGS. 2a, 2b and 2c represent an example of a pivoting micro-mirror according to the invention in three different positions.

This micro-mirror comprises a fixed part 31 and a movable part 41 placed above the fixed part and linked to the latter via a pivot hinge 47. In this example, the pivot hinge is centred under the movable part but, depending on the applications of the micro-mirror, the pivot hinge may be off-centre.

Lower electrodes 33 are placed on the side of the fixed part facing the movable part and an upper electrode 43 is placed on the side of the movable part facing the fixed part so that at least part of the upper electrode faces at least part of each of the lower electrodes. In FIG. 2, which are sectional views according to a perpendicular plane to the layer plane and going through the pivot hinge, only two lower electrodes are represented on either side of the pivot hinge. These electrodes are linked to lines of connection 62 placed on the same side. A supplementary electrode 33′ placed under the pivot hinge, on the fixed part, allows the upper electrode to be connected via the pivot hinge to a connection line (not in the plane of FIG. 2).

To increase the angular excursion of the movable part, the fixed part further comprises cavities 36 facing the ends of the movable part. These cavities are preferably peripheral and therefore form but a single cavity.

FIG. 2a shows the movable part placed in a plane parallel to the plane of the support; FIG. 2b illustrates the movable part upon pivoting around an axis of rotation perpendicular to that of the pivot hinge and perpendicular to the plane of the figure, one of the ends of the movable part lying in the cavity 36; FIG. 2c illustrates the movable part pivoting around the same axis of rotation but at 180°, the opposite end of the movable part now lying in the cavity 36.

The description that follows describes two manufacturing processes of a micro-mirror of the invention knowing on one hand that these processes allow for a collective manufacturing of micro-mirrors and on the other hand that numerous variations of these processes can be used whilst remaining within the context of the invention. The first process is carried out on a wafer whereas the second process is carried out on two separate wafers A and B and then applied.

In addition, to simplify the description the example chosen to make a micro-mirror uses silicon for the support, the second layer and the pivot hinge and a thermal silicon dioxide for the first layer.

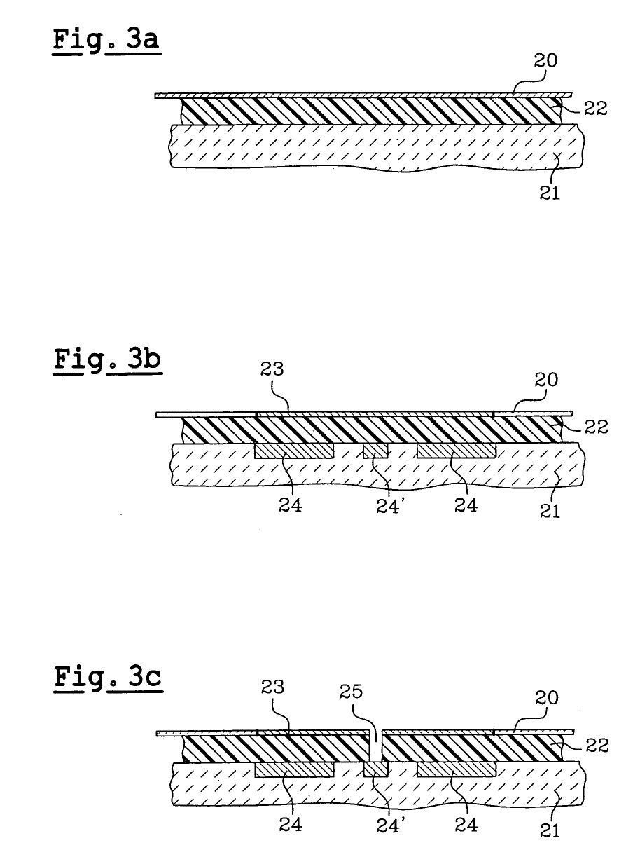

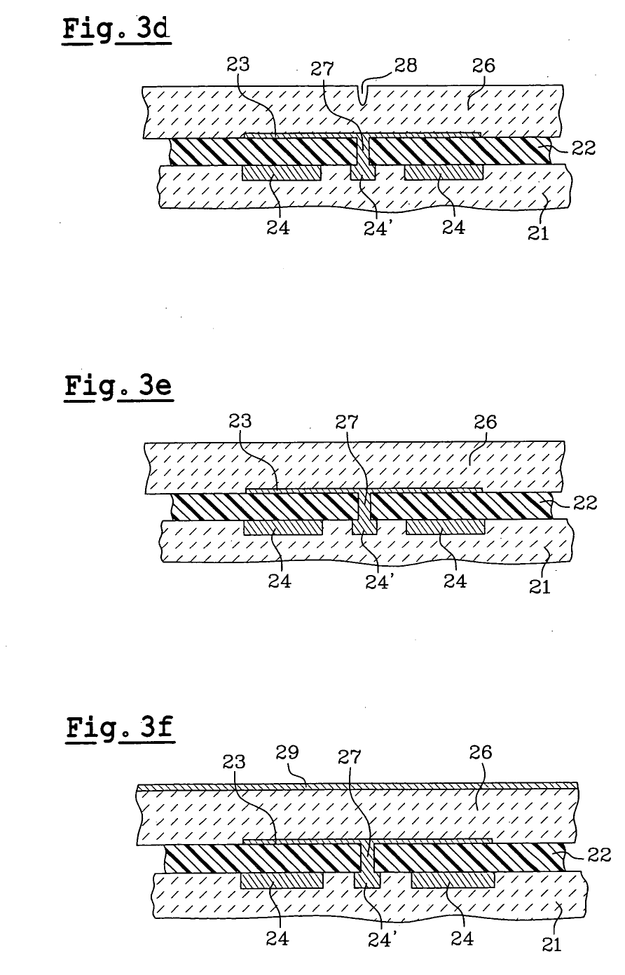

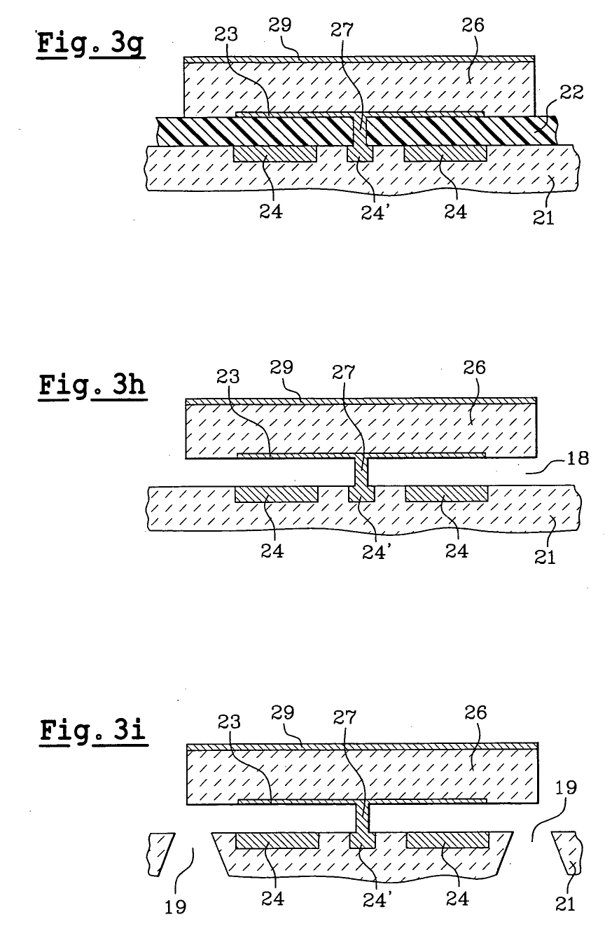

The first embodiment of the micro-mirror of the invention which is implemented on a wafer is illustrated in the different FIG. 3.

For this purpose, a wafer of type SOI “Silicon On Insulator” is made (see sectional view in FIG. 3a) or a wafer of this type, available on the market, can be used.

To make such a wafer a non-doped silicon support 21 is used on which a dielectric layer of thermal silica 22 is developed. The thermal dioxide layer is preferably made via oxidation at high temperature in dry atmosphere (between 800° C. and 1,100° C. in oxygen) or in damp atmosphere (between 800° C. and 1,100° C. in water vapour) and at standard atmospheric pressure or at high pressure.

A surface layer of single-crystal silicon 20 is then applied using any of the known depositing techniques and in particular those of applying thin layers.

FIG. 3b shows the making of the electrodes of the means of electric control by the creating of different doped zones 24, 24′ and 23 in the upper part of the support in non-doped silicon 21 and in the surface layer of single-crystal silicon 20. These zones are obtained via ion implantation of dopant atoms (generally Boron or Phosphor) with different energies depending on the desired depth of localisation, followed or not by thermal annealing. According to the desired depths of localisation and the thickness of the dielectric layer 22, the implantation energies typically lie between 20 and 300 keV and the implanted doses between 10¹⁴ and 10¹⁶ cm². By way of example, in the layer 20, of thickness W′ typically lying between 0.1 micron and 0.6 micron, the implantation energies to create the zones 23 will be weak (15 to 100 keV) whilst in the support 21, as the implanted ions must go through the layer of silicon 22 of thickness W and a part of the silicon layer 21, the implantation energies to create the zones 24 and 24′ will be greater (generally greater than 100 keV).

FIG. 3c shows the creation of the housing 25 for the future pivot hinge via local etching of the layers 20 and 22 to create a via above the implanted zone 24′.

FIG. 3d illustrates the epitaxy stage. This stage allows to make the pivot hinge in doped single-crystal silicon as well as to increase the thickness of the surface silicon 20 so as to improve the mechanical rigidity of what will make up the movable part of the micro-mirror.

During this epitaxy stage, the doping rate of the epitaxy material can be modified and for example chosen to be greater at the beginning of the stage (corresponding to the creation of the pivot hinge 27 which must be electrically linked to an implanted zone of the support) than at the end of the process when it is only a matter of increasing the thickness of the layer 20 to create the layer of single-crystal silicon 26 whose thickness can be as much as several microns depending on the desired specifications. The depression 28 that could arise in this epitaxy layer is due to the presence of the local etching 25.

FIG. 3e shows a sectional view of the device after the epitaxy stage and the thinning stage for example via a mechano-chemical polishing needed to remove the depression 28 and obtain a layer of single-crystal silicon 26 of perfect flatness. Other thinning techniques can of course be used and in particular the one described in the U.S. Pat. No. 5,374,564 or in the U.S. Pat. No. 6,020,252.

FIG. 3f shows the making of the means of reflection via the creating on the layer 26 of a mirror layer 29 with high reflective qualities to the wave lengths used by a micro-mirror for example via the depositing of metallic or dielectric multilayers.

FIG. 3g illustrates the etching stage of the future movable part of the micro-mirror. This etching, whose geometry and dimensions depend on the expected optical specifications and therefore the targeted applications (for example squares of sides or circles of diameters of about several tens of microns to a few millimetres), puts into play the layers 29 and 26 and possibly the layer of thermal silica 22.

This etching is made for example via any type of etching adapted to the materials put into play (ion etching, reactive ion etching and/or chemical etching).

By way of example, for layers 29 in aluminium, 26 in silicon, this etching is carried out through a mask (not illustrated) via a first reactive ion attack for example with chlorine gas to attack the aluminium, then via a second reactive ion attack for example with a SF₆ gas to attack the silicon.

FIG. 3h shows a sectional view of the component after the removal of the sacrificial layer of silica 22 at least under the movable part of the micro-mirror and therefore the freeing of this movable part. The removal of the layer 22 is carried out for example for a layer of silicon dioxide via a chemical attack with hydrofluoric acid or via a reactive ion attack with fluorinated gas.

In the structure represented in FIG. 3h the amplitude Δθ of the total angular excursion is determined by the height H of the pivot hinge and the width L of the movable part in its rotation plane (sinus Δθ=H/2L); the ends of the movable part of the micro-mirror can then abut with the plane of the support. This configuration therefore has the inconvenience, for a given height H of the pivot hinge, to entirely link the total angular excursion Δθ and the dimension L of the movable part in the considered rotation plane.

FIG. 3i provides a means of overcoming this inconvenience by making in the support 21 cavities 19 that do or do not go through and whose inside edges are located at a distance L′ from the axis of the pivot hinge smaller than L/2 and the outside edges at a distance L″ greater than L/2.

The angular excursion Δθ defined by the relation tangent Δθ=H/L′ thus only depends on L′ and no longer on L.

This cavity can be easily made from the rear side of the wafer, for example preferably via chemical etching as illustrated in FIG. 3i, and therefore it must transverse the thickness of the silicon support.

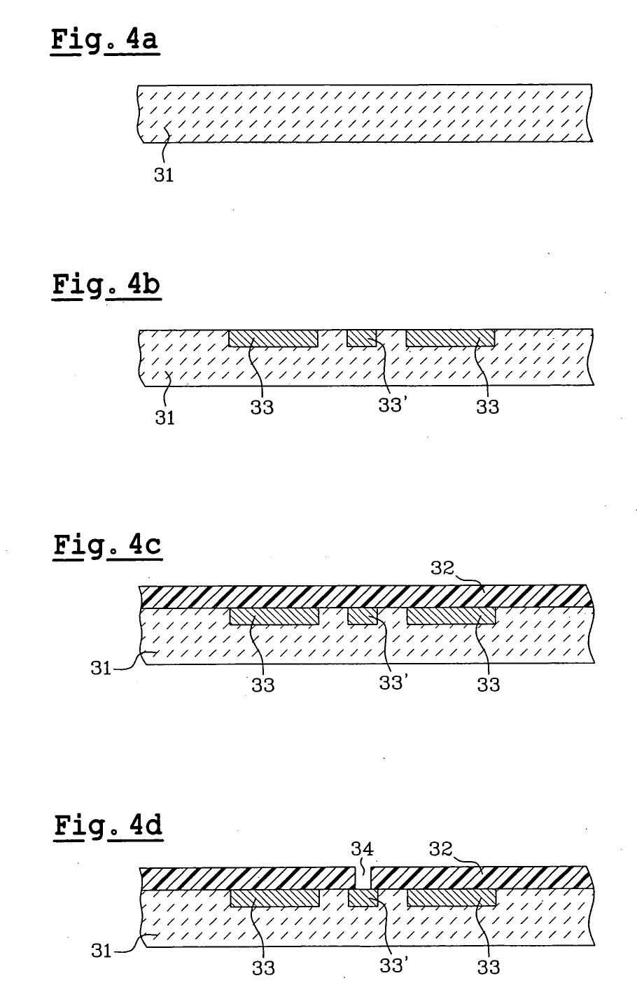

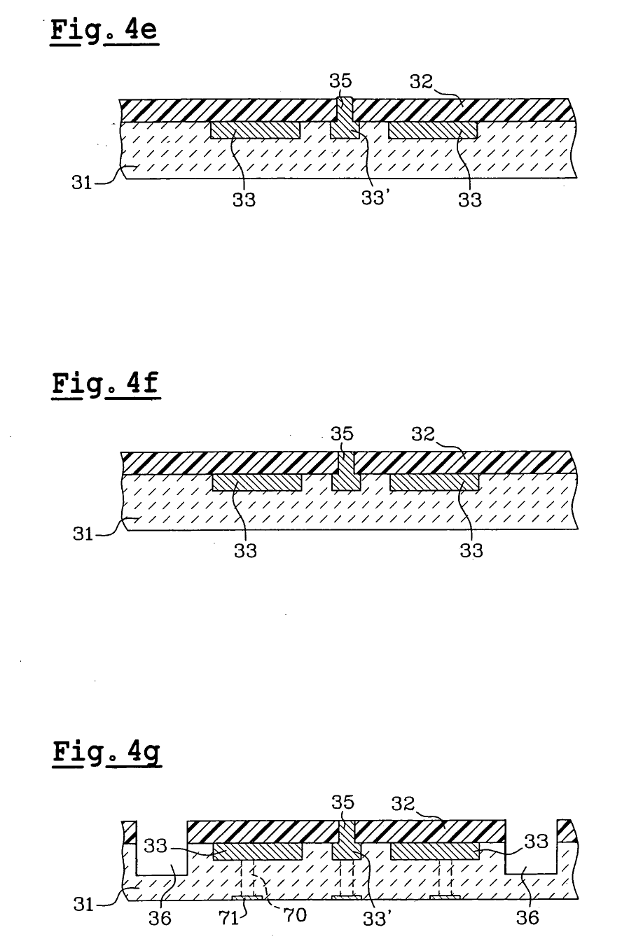

The second embodiment of the invention that carries out the stages of the process on two wafers A and B and then applies these wafers is represented in FIGS. 4, 5 and 6.

Preparation of Wafer A

Using a mechanical support, for example a non-doped silicon wafer 31 (FIG. 4a), the different electrodes 33 and 33′ of the fixed part are made via ion implantation followed or not by thermal annealing (FIG. 4b). FIG. 4c illustrates a stage of thermal oxidation of the support, designed to create a thermal dioxide layer 32 of perfectly controlled thickness in general lying between 1 and 3 microns; during this stage, generally performed under high temperature, there is a diffusion of the dopants of the implanted zones and an increase in the volume taken up by these zones.

The stages represented in FIG. 4b and FIG. 4c can be inverted at the cost of increasing the implantation energies to make the doped zones 33 and 33′ (the implanted ions must then go through the thermal silica layer).

FIG. 4d shows the next stage corresponding to the creation of the localised etching 34 of the thermal silica layer 32 above the doped zone 33′ to form a via. Thus, FIG. 4e illustrates an epitaxy stage which allows the doped single-crystal silicon to increase in the via 34. The part of the articulation element 35 thus created generally has a thickness very slightly greater than the silica layer 32; this part of the element will constitute part of the future pivot hinge. FIG. 4f illustrates a mechano-chemical polishing stage designed to flatten the surface of the wafer A and “rub out” any surplus thickness of the articulation element 35.

FIG. 4g represents an etching stage of cavities 36 which render the dimensions of the movable part independent from the angular excursion Δθ of the said part. The dimensions (position in relation to the axis of the future pivot hinge, width and depth) of the openings 36 are set on the basis of the dimensions of the movable part and of the desired angular excursion Δθ according to the different axes of rotation.

Contrary to the case where the process of the invention is carried out on a wafer and in which the cavities 19 must transverse the support, in this second embodiment, where the process is carried out on two wafers which are then applied, the cavities 36 can be of a thickness much less than the thickness of the support 31. These cavities can be in any form and in particular surround the pivot hinge.

Preparation of Wafer B

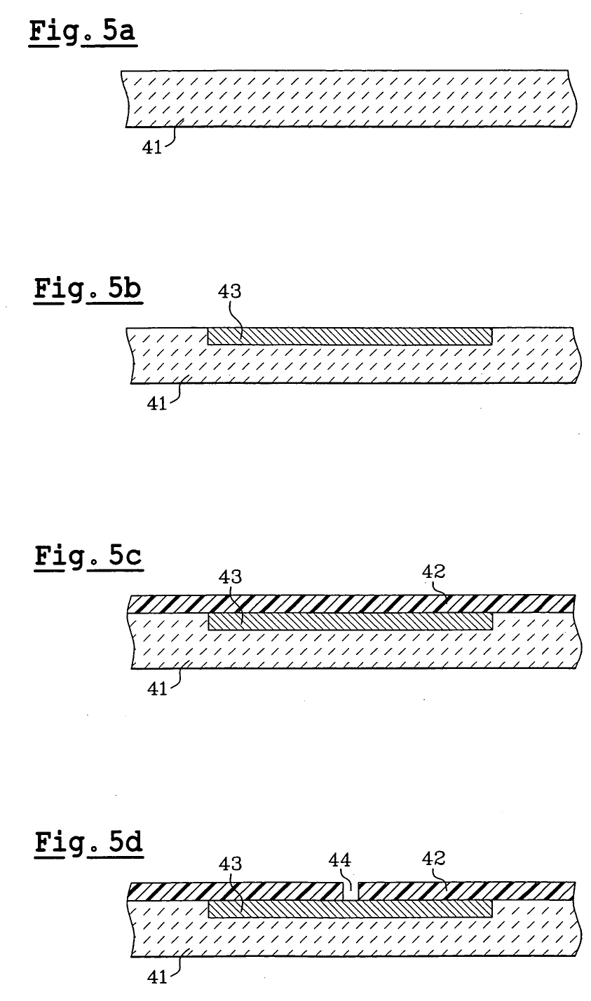

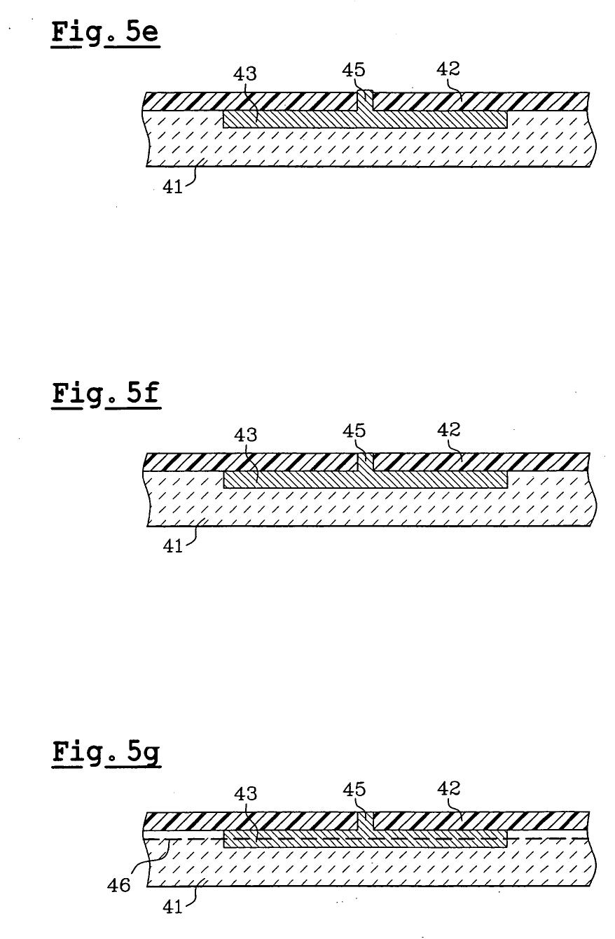

FIG. 5 show the different manufacturing stages of wafer B. First of all a substrate 41 (FIG. 5a) is taken, for example in single-crystal silicon, from which an electrode 43 is created for example via an ion implantation (FIG. 5b) followed or not by a thermal annealing. Then, a thermal dioxide layer 42 (FIG. 5c) is created in the same way as for layer 32. This layer 42 is then etched to form a via 44 (FIG. 5d) which extends as far as the electrode 43; this opening has dimensions very similar to those of the opening 34 (FIG. 4d); an epitaxy stage (FIG. 5e) using single-crystal silicon thus allows the creation in the opening 44 of another part of the pivot hinge which is made in doped single-crystal silicon 45. A mechano-chemical polishing stage (FIG. 5f) allows, if necessary, a perfect flattening of the surface of the wafer B to be obtained.

The stage illustrated in FIG. 5g consists in creating a connection zone 46 in the wafer 41 such as an embrittlement zone created for example by an implantation. This zone delimits within the wafer a layer (previously called the second layer) of thickness typically lying between 0.1 and 2 microns between the silica layer 42 and the rest of the wafer (which can be an intermediate support). This embrittlement zone enables the separation of the second layer from the rest of the wafer, either prior to application or, most of the time after application (see in particular the U.S. Pat. No. 5,374,564 and U.S. Pat. No. 6,020,252).

Assembling of Wafers A and B

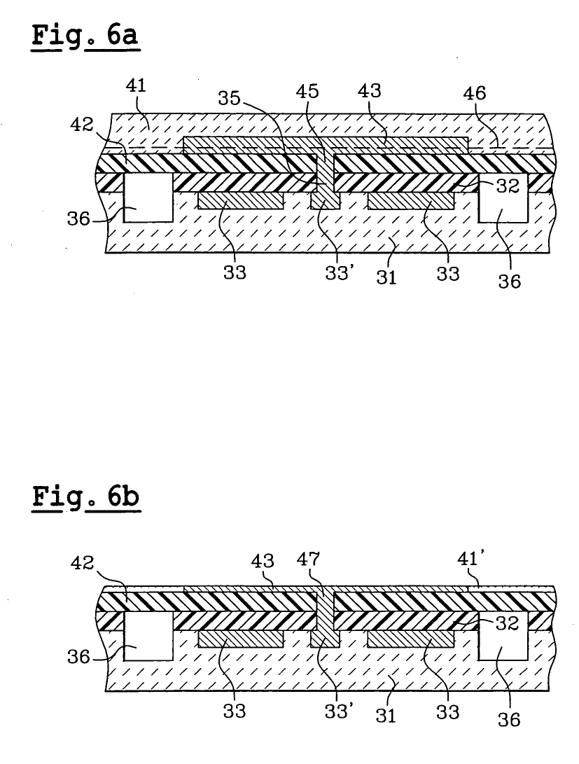

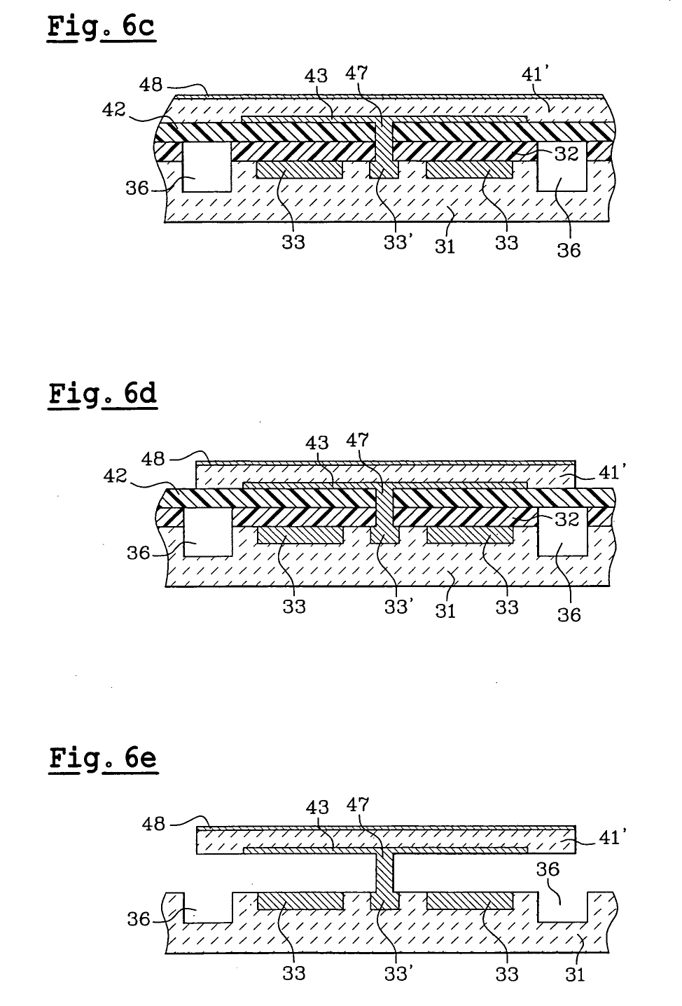

The first stage illustrated in FIG. 6a consists in assembling the two wafers A and B, oxidised sides against each other. During this assembling, the positioning of the two wafers is carried out so as to align the two parts of the pivot hinge 35 and 45 and to create the pivot hinge 47.

Sealing can be favourably performed via the known molecular adhesion techniques.

The two wafers A and B being assembled, the upper part of the layer 41 of the wafer B is separated from the unit A and B at the level of the embrittlement zone 46. This separation can be favourably carried out through a thermal and/or mechanical treatment. Once this separation has been completed there only remains (see FIG. 6b) a thin layer of single-crystal silicon 41′ possibly comprising zones of different dopages.

If the layer 41′ is too thin the process can further comprise (see FIG. 6c) an epitaxy stage designed to increase the thickness of the single-crystal film 41′ so as to increase the mechanical rigidity of what will constitute the movable part of the mirrors, and this stage can be followed by a mechano-chemical polishing stage to flatten the surface. The final thickness of this layer 41′ lies for example between 5 and 60 μm.

A layer 48 with high reflectivity to the operating optic wave lengths, either metallic or dielectric multilayer, is then deposited on the layer 41′.

FIG. 6d shows the next stage of the etching of the layers 41′ and 48 according to the desired pattern for the movable part of the future micro-mirror. This etching is made through a non-illustrated mask.

FIG. 6e illustrates the stage of the freeing of the movable part around the pivot hinge 47 via the removal of the sacrificial layers of thermal silica via chemical attack, for example with the help of an attack bath using hydrofluoric acid or by a reactive ion attack with fluorinated gas.

The different manufacturing stages presented in the various FIGS. 3 to 6 can have numerous variations. In particular the order of the different stages can in some cases be inverted and some of the stages can be modified.

Thus, for example, a single thermal oxidation layer could have been performed on the wafer A and thus create the pivot hinge via a single element in this layer; the single-crystal silicon layer would have been applied directly to this dioxide layer.

To simplify the description, the lines of connection of the electrodes and the connectors to an electric control unit were not represented in the previous figures.

These lines of connection can be created in different ways and notably via ion implantation followed or not by an appropriate thermal diffusion of the dopants. These lines are advantageously made on the front side of the support facing the movable part, the electrode of the movable part being linked to some of these lines via the pivot hinge if the latter is conductive and via the electrode 33′. These lines of connection can also be made via metallic holes through the support, the electrode of the movable part being linked to some of these metallic holes via the pivot hinge if the latter is conductive and via the electrode 33′.

By way of example, FIG. 4g only represents with dotted lines the making through the support of metallic holes 70 linking the electrodes 33 and 33′ to connectors 71.

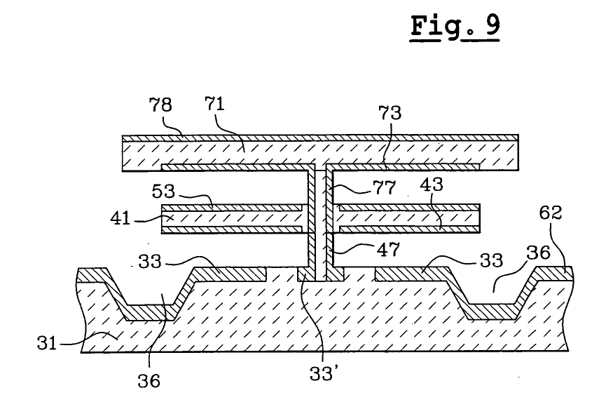

When the micro-mirror must turn around at least two perpendicular axes of rotation whilst maintaining the advantage of separating the angular excursion Δθ value from the dimension L of the movable part, cavities completely surrounding the pivot hinge 47 are advantageously made in the support. In the case where the lines of connection are made on the front side of the support, so as not to cut through the cavities, the lines of electric connection (by way of example represented in FIG. 9 and designated by 62) energising the different electrodes, the support is etched so as to create a peripheral cavity before creating the doped zones 33 and 33′.

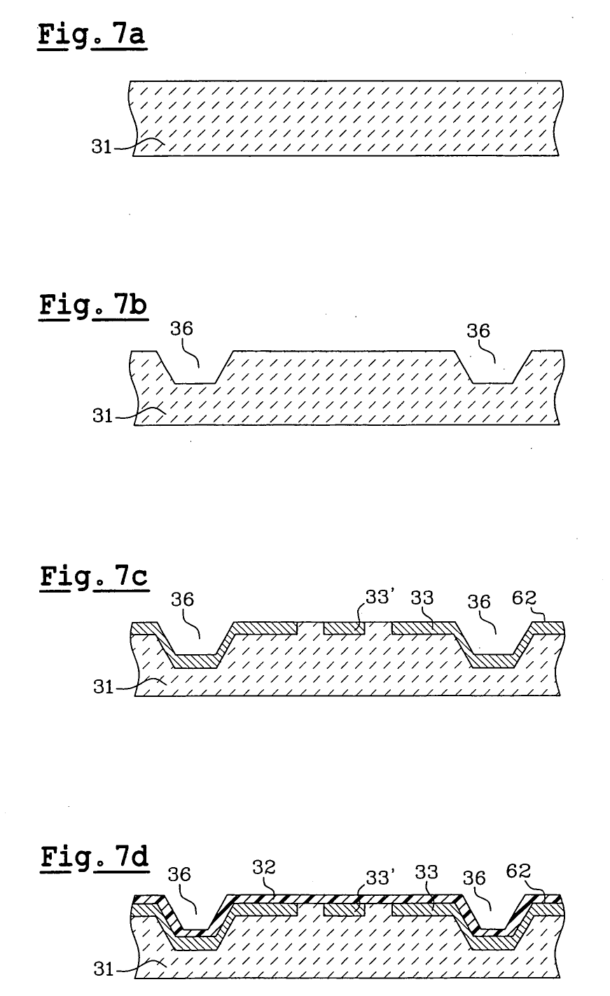

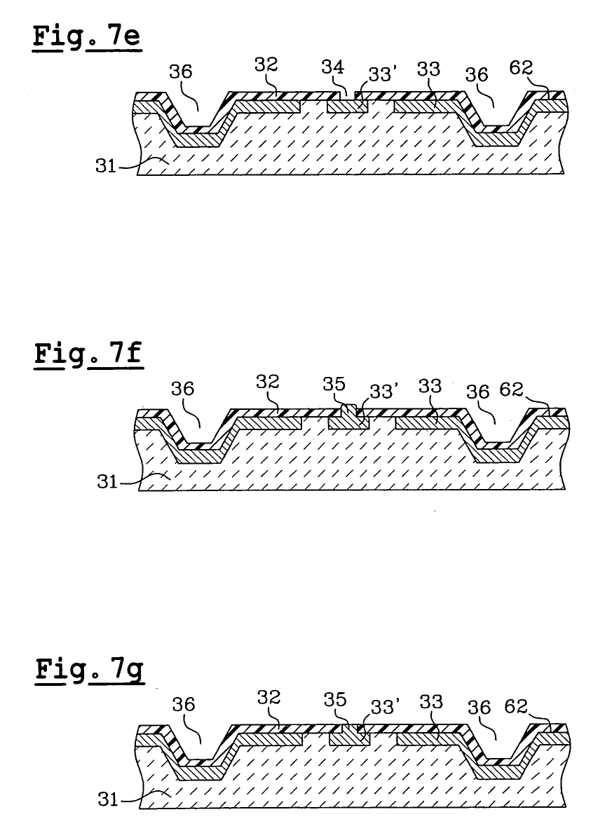

FIG. 7 illustrate this process variation.

From a wafer 31 (see FIG. 7a) a cavity 36 is created via etching done through different methods such as reactive ion etching (corresponding to the shape of the cavity in FIG. 3g) or preferably through chemical etching (corresponding to the shape of the cavity in FIG. 7b). In all cases, the geometry (shape and dimension) of the cavity 36 is determined by the shape (which can be circular, square, rectangular, octagonal . . . ) and the dimensions of the movable part of the micro-mirror and of the desired total angular excursion Δθ value according to the different axes of rotation; the total angular excursion Δθ value can, in addition, have different values Δθ₁, Δθ₂ . . . according to each of the axes of rotation.

The other manufacturing stages represented in FIG. 7c (making of the doped zones), FIG. 7d (making of thermal dioxide), FIG. 7e (making of a via 34 in the dioxide layer), FIG. 7f (epitaxy to make a part of the pivot hinge) and FIG. 7g (flattening of the structure) can be identical to those previously described. To obtain the final structure, an application is then made to the wafer obtained in FIG. 7g, for example the wafer obtained in FIG. 5g, and then the remaining stages of the process are carried out as described in reference to FIG. 6. The micro-mirror which is obtained is for example the one represented in FIG. 2.

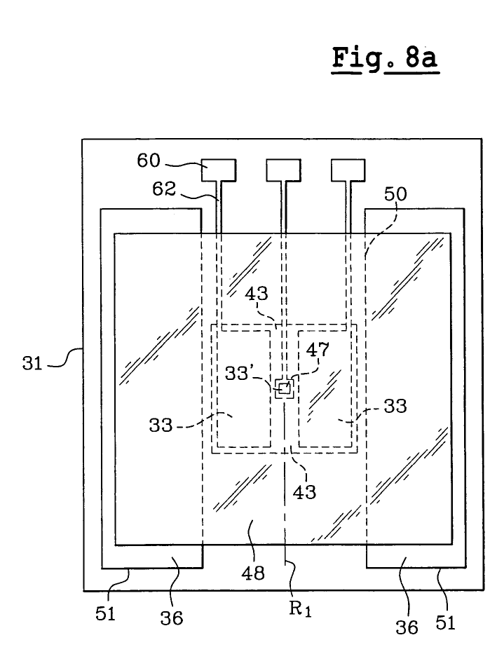

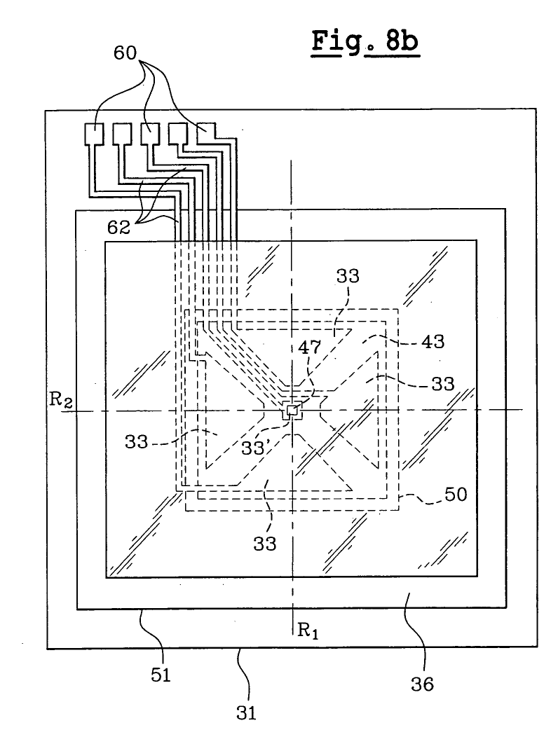

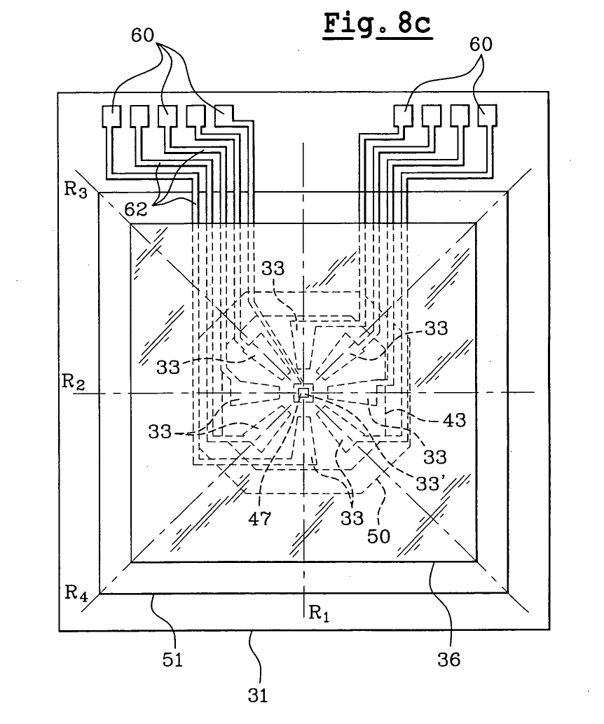

FIG. 8a shows a top view of a geometry of lower electrodes 33 in the fixed part. The electrodes allowing the movable part to oscillate according to two positions around a single axis of rotation R1, amount to two and are placed symmetrically in relation to the axis of rotation R1 which goes through the pivot hinge 47, the central electrode 33′ only allows the electric connection of the movable part.

FIG. 8b shows a geometry of lower electrodes 33 allowing four positions around two perpendicular axes of rotation R1 and R2, going through the pivot hinge; there are four of these electrodes 33 groups in pairs, each pair of electrodes being placed symmetrically in relation to one of the axes, likewise, the central electrode 33′ only allows the electric connection of the movable part.

A large number of pairs of electrodes can thus be envisaged, placed on either side of an axis of symmetry. FIG. 8c gives an example with four axes of rotation (R1, R2, R3, R4) at 45° to each other and four pairs of lower electrodes 33 placed in sectors around the axis of the pivot hinge.

In FIGS. 8a, 8b and 8c the different key elements of the micro-mirrors are represented in a transparent manner. Represented are the sets of lower electrodes 33 (electrodes of the fixed part), and the upper electrode 43 (the electrode of the movable part); the lower electrode 33′ which is electrically linked to the upper electrode via the pivot hinge 47 is drawn in dark grey whereas in FIG. 8b the two sets of electrodes allowing to control the rotation of the micro-mirror to be controlled according to each of the perpendicular axes of rotation are drawn in two different shades of lighter grey. The reflective surface 48 of the movable part and the traces 50 and 51 of the etched zones 36 allowing the separation of the variable dimensions of the micro-mirror and the total angular excursion Δθ are also represented.

Also represented, skeletally, are the lines of connection 62 of the electrodes to the connectors 60, these connectors being capable of being connected to an electric control unit (not represented).

The different aforementioned functions can of course be carried out as much in the case of the use of a single wafer as for several wafers. The usage of more than two wafers can be envisaged to allow, in particular, the making of complex structures, for example micro-mirrors with several superimposed movable parts.

FIG. 9 represents a skeletal sectional view of an example of a micro-mirror with two movable parts on a fixed part 31.

The first movable part comprises a second layer 41; it is linked to the fixed part via a pivot hinge 47. The second movable part comprises a second layer 71 and a reflective layer 78; it is linked to the first movable part via a pivot hinge 77.

In this example, to allow the control of the micro-mirror, the movable part 71 comprises an electrode 73 and the movable part 41 comprises electrodes 53 placed in sectors around the pivot hinge 77, the electrodes 73 and 53 being placed facing each other; moreover, the movable part 41 comprises electrodes 43 placed in sectors around the pivot hinge 47, these electrodes being placed facing the electrodes 33 of the fixed part.

In this example, the axes of the pivot hinges 47 and 77 are merged; these are multi-element pivot hinges that allow the electrodes 73, 53 and 43 of the movable parts 41 and 71 to be linked to an electric control unit via lines of connection 62 placed on the fixed part.

This principle can of course be extended to more than two upper movable parts.

### REFERENCES

“Mirrors on a chip”, IEEE SPECTRUM, November 1993

L. J. Hornbeck, “Micro-machining and micro-fabrication” “95”, October 1995, Austin (US)

D. J. Bischop and V. A. Aksyuk, “Optical MEMS answer high-speed networking requirements”, Electronic Design, Apr. 5, 1999.

1. Micro-mirror comprising a fixed part (31), a movable part (41, 48) comprising means of reflection (48) and means of articulation linking the movable part to the fixed part, this micro-mirror is characterised in that the means of articulation are made of a pivot hinge (47) located under the movable part between the latter and the fixed part and capable of allowing displacement of the movable part according to axes of rotation (R1, R2, R3, R4) contained in the movable part and going through the axis of the pivot hinge, and in which the fixed comprises at least a cavity (36) facing at least a zone of an end of the movable part.

2. Micro-mirror according to claim 1, characterised in that it further comprises means of electrically controlling the displacement of the movable part according to all or some of the said axes of rotation.

3. Micro-mirror according to claim 2, characterised in that the means of electric control comprise a set of electrodes (33), known as lower, placed on the fixed part, on a so-called front side, facing the movable part, and a set of electrodes (43), known as upper, placed on the movable part, on a so-called rear side, facing the lower electrodes.

4. Micro-mirror according to claim 3, characterised in that the set of lower electrodes comprises at least 2.n electrodes (33) placed in sectors around the axis of the pivot hinge, n being the chosen number of axes of rotation that can be attributed to the movable part and the set of upper electrodes comprises a single electrode (43) placed so as to face at least part of each of the 2.n lower electrodes.

5. Micro-mirror according to claim 3, characterised in that the means of electric control further comprise lines of connection (62) and connectors (60) on the ends of the lines to link the lower and upper electrodes to an electronic control unit, these lines of connection and these connectors are fitted to the front side of the fixed part, the set of upper electrodes being linked to one or several of these lines via the pivot hinge and one or several electrodes (33′) placed under the pivot hinge, on the front side of the fixed part.

6. Micro-mirror according to claim 3, characterised in that the means of electric control further comprise lines of connection (62) and connectors (60) on the ends of the lines to link the lower and upper electrodes to an electronic control unit, these lines of connection consist of metallic holes (70) through the fixed part, the set of lower electrodes being electrically connected to the said holes and the set of upper electrodes being linked to one or several of these metallic holes via the pivot hinge and one or several electrodes (33′) placed under the pivot hinge, on the front side of the fixed part, the connectors (71) being located at the ends of these holes on a rear side of the fixed part, opposite the front side.

7. Micro-mirror according to claim 1, characterised in that this cavity is peripheral and faces a peripheral zone of the end of the movable part.

8. Micro-mirror according to claim 1, characterised in that the means of reflection comprise a layer of reflective material applied on the so-called front side of the movable part, opposite to the one facing the fixed part.

9. Micro-mirror according to any one of the previous claims, characterised in that it comprises on the fixed part at least two superimposed movable parts, the first movable part (41, 48) being linked to the fixed part (31) via a first pivot hinge (47) comprising a first axis and the second movable part (71, 78) being linked to the first movable part via a second pivot hinge (77) comprising a second axis, this micro-mirror further comprising means of control capable of displacing the first movable part around n₁ axes of rotation contained in this first part and going through the first axis and the second movable part around n₂ axes of rotation contained in this second part going through the second axis, with at least the second movable part comprising means of reflection.

10. Matrix of micro-mirrors using micro-mirrors according to any one of the previous claims.

11. Matrix of micro-mirrors according to claim 10, characterised in that each micro-mirror comprises means of control capable of articulating each micro-mirror independently from each other.

12. Manufacturing process of the micro-mirror, characterised in that it comprises the following stages:
a) the making of a stack consisting of a mechanical support designed to constitute the fixed part, of a sacrificial layer of material called the first layer and a set designed to constitute the movable part and comprising at least one layer of material called the second layer;
b) the making of the pivot hinge;
c) the making of the movable part by etching at least the second layer of material so as to obtain at least one pattern;
d) the eliminating of the sacrificial layer so as to free the said movable part which is then linked to the rest of the structure corresponding to the fixed part, via the pivot hinge,
the process further comprising the making of one or several cavities through etching in one side of the fixed part facing the movable part.

13. Manufacturing process of the micro-mirror according to claim 12, characterised in that the means of reflection are applied to the second layer through the depositing of single or multiple layers of reflective materials.

14. Manufacturing process of the micro-mirror according to claim 12, characterised in that the first layer is obtained through thermal oxidisation of the support and/or of the second layer.

15. Manufacturing process of the micro-mirror according to claim 12, characterised in that it further comprises an epitaxy stage for the second layer, the means of reflection then being applied on the second layer after epitaxy.

16. Manufacturing process of the micro-mirror according to claim 12, characterised in that the stacking of stage a) can be obtained through the application of the sacrificial layer of material on the support, then the depositing of the second layer.

17. Manufacturing process of the micro-mirror according to claim 12, characterised in that stage a) consists in, on the mechanical support, applying the second layer, the support and/or the second layer comprising on their sides to be applied a sacrificial layer which will form the first layer once after application.

18. Manufacturing process of the micro-mirror according to claim 17, characterised in that the application comprises a sealing stage via molecular adhesion.

19. Manufacturing process of the micro-mirror according to claim 12, characterised in that the second layer is associated with an intermediate support via a connection zone capable of allowing the retraction of the intermediate support.

20. Manufacturing process of the micro-mirror according to claim 12, characterised in that the pivot hinge is obtained through a localised etching of the layer (s) located above the support so as to form a via and through the depositing of a material in the via, the material deposited in the via constituting all or part of the pivot hinge.

21. Manufacturing process of the micro-mirror according to claim 17, characterised in that the pivot hinge is made via:
localised etchings prior to application so as to form a first via in the layer (s) located above the support, and so as to form a second via in the layer (s) located on the second layer, facing the support;
a depositing of material through the first via creating a first part of the pivot hinge and a depositing of material in the second via creating a second part of the pivot hinge, these two parts being placed face to face during the application and forming after the application the pivot hinge.

22. Manufacturing process of the micro-mirror according to claim 20 or 21, characterised in that the depositing of material is carried out via an epitaxy.

23. Manufacturing process of the micro-mirror according to claim 12, characterised in that it comprises a thinning stage of the second layer.

24. Manufacturing process of the micro-mirror according to claim 12, characterised in that the micro-mirror being controlled electrically, and the fixed part and the movable part being, at least in the facing parts, in semiconductive materials, the process of the invention comprises a stage to make a set of lower electrodes and a set of upper electrodes on the sides of the fixed and movable parts that face each other, via an ion implantation of dopants followed or not by an appropriate thermal diffusion of the implanted dopants.

25. Manufacturing process of the micro-mirror according to claim 24, characterised in that lines of connection of the lower and upper electrodes to an electric control further are made through an ion implantation of dopants followed or not by an appropriate thermal diffusion of the dopants, these lines are made on the front side of the fixed part facing the movable part, the set of upper electrodes being linked to one or several lines via the pivot hinge and at least one electrode (33′) placed under the pivot hinge on the fixed part; connectors can also be envisaged at the ends of these lines so as to connect them to the electric control.

26. Manufacturing process of the micro-mirror according to claim 24, characterised in that lines of connection of the upper and lower electrodes consist of metallic holes through the fixed part, the set of upper electrodes being linked to one or several of these metallic holes via the pivot hinge and at least one electrode (33′) placed under the pivot hinge, on the fixed part; connectors can also be envisaged at the ends of these holes on the side of the fixed part that is opposite to the one bearing the lower electrodes, so as to connect them to lines to an electric control unit.

27. Process according to claim 12, in which the fixed part is in silicon, the first layer is in silicon dioxide, the second layer is in single-crystal silicon and the pivot hinge is in single-crystal silicon.
